(19) United States
(12) Patent Application Publication
(10) Pub. No.: US 2012/0280892 A1
(43) Pub. Date: Nov. 8, 2012

(54) Multi-Directional Multi-Screen Display System

(76) Inventor: Jerry Moscovitch, Toronto (CA)

(21) Appl. No.: 13/549,117

(22) Filed: Jul. 13, 2012

Related U.S. Application Data
(63) Continuation of application No. 11/622,050, filed on Jan. 11, 2007.
(60) Provisional application No. 60/766,327, filed on Jan. 11, 2006.

(51) Int. Cl. G09G 3/36; G09G 5/00

(52) U.S. Cl. 345/1.3; 345/87

(57) ABSTRACT

A multi-screen display system is described that includes a base, a column coupled to the base and an arm coupled to the column. The system also includes a first monitor, a first monitor connector for connecting the rear of the first monitor to the arm, a second monitor, and a second monitor connector for connecting the rear of the second monitor to the arm. The system further includes an extension, such that the first monitor and the second monitor are capable of being a) removed from the arm, b) connected together by connecting the first monitor connector to the second monitor connector via the extension, and c) supported on a work surface by resting the bottom edge of the first monitor and the bottom edge of the second monitor thereon, such that the angle between the first screen and the second screen can exceed two hundred and seventy degrees.

### CROSS-REFERENCE TO RELATED APPLICATION

This application is a continuation of application Ser. No. 11/622,050 filed on Jan. 11, 2007, which claims priority to provisional application no. 60/766,327 filed on Jan. 11, 2006.

### FIELD OF THE INVENTION

This invention relates to multi-screen display systems, and in particular to multi-directional multi-screen systems.

### BACKGROUND OF THE INVENTION

The number of multi-monitor or multi-screen computer display systems has increased in recent years as computer users in various industries adapt their use to new environments. For example, a multi-monitor display system can be used to create the illusion of a larger screen, thereby allowing a securities trader to view a large single spreadsheet over several displays. Alternately, the trader may view individual applications on individual screens (for example, one screen may display a Web Browser, a second a new service and a third a spreadsheet of financial data).

An individual working with still or moving images, such as a graphics artist, video or film editor or medical diagnostician may also use multi-monitor display systems. A given image may be viewed across several screens or two images may be viewed side-by-side (such as two x-ray images used to assess the extent to which a broken bone has healed). It would also be advantageous to modify multi-screen display systems so that more than one person could use a particular multi-screen display system for the aforementioned applications.

### SUMMARY OF THE INVENTION

A multi-screen display system is described that includes a base, a column coupled to the base and an arm coupled to the column. The system also includes a first monitor, a first monitor connector for connecting the rear of the first monitor to the arm, a second monitor, and a second monitor connector for connecting the rear of the second monitor to the arm. The system further includes an extension, such that the first monitor and the second monitor are capable of being a) removed from the arm, b) connected together by connecting the first monitor connector to the second monitor connector via the extension, and c) supported on a work surface by resting the bottom edge of the first monitor and the bottom edge of the second monitor thereon, such that the angle between the first screen and the second screen can exceed two hundred and seventy degrees.

### BRIEF DESCRIPTION OF THE DRAWINGS

FIG. 1 shows a perspective, primarily back view of a multi-screen display system, in accordance with the principles of the present invention.

FIG. 2 shows another perspective, primarily back view of a multi-screen display system, in accordance with the principles of the present invention.

FIG. 3A shows another perspective, primarily back view of a multi-screen display system, in accordance with the principles of the present invention.

FIG. 3B shows the back of a monitor of the multi-screen display system shown in FIG. 1.

FIGS. 4-6 show a connector apparatus that includes a support connector and its complimentary screen-mounted connector, which are similar to the support connectors, and complimentary screen-mounted connectors of FIGS. 1-3B.

FIG. 7 shows a ball joint for connecting the support connector to the arm or column of FIGS. 1-3B.

FIG. 8 shows components that permit a monitor to rotate, in accordance with the principles of the present invention.

FIG. 9 shows a rotatable monitor of the display system of FIGS. 1-3B.

FIGS. 10A-C show another embodiment of a multi-screen display system, in accordance with the principles of the present invention.

FIGS. 11A-C show another embodiment of a multi-screen display system, in accordance with the principles of the present invention.

FIGS. 12A and 12B show the connectors of FIGS. 11A-C.

FIG. 13A shows another embodiment of connectors for a multi-screen display system.

FIG. 13B shows a multi-screen display system in which the connectors of FIG. 13A are used.

### DESCRIPTION OF THE INVENTION

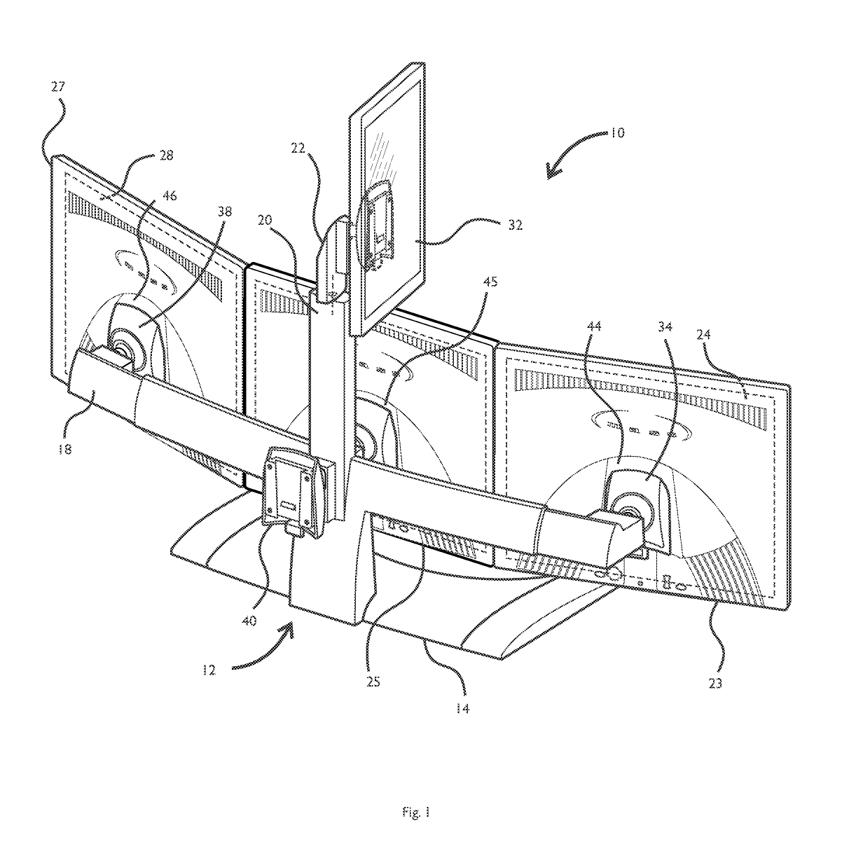

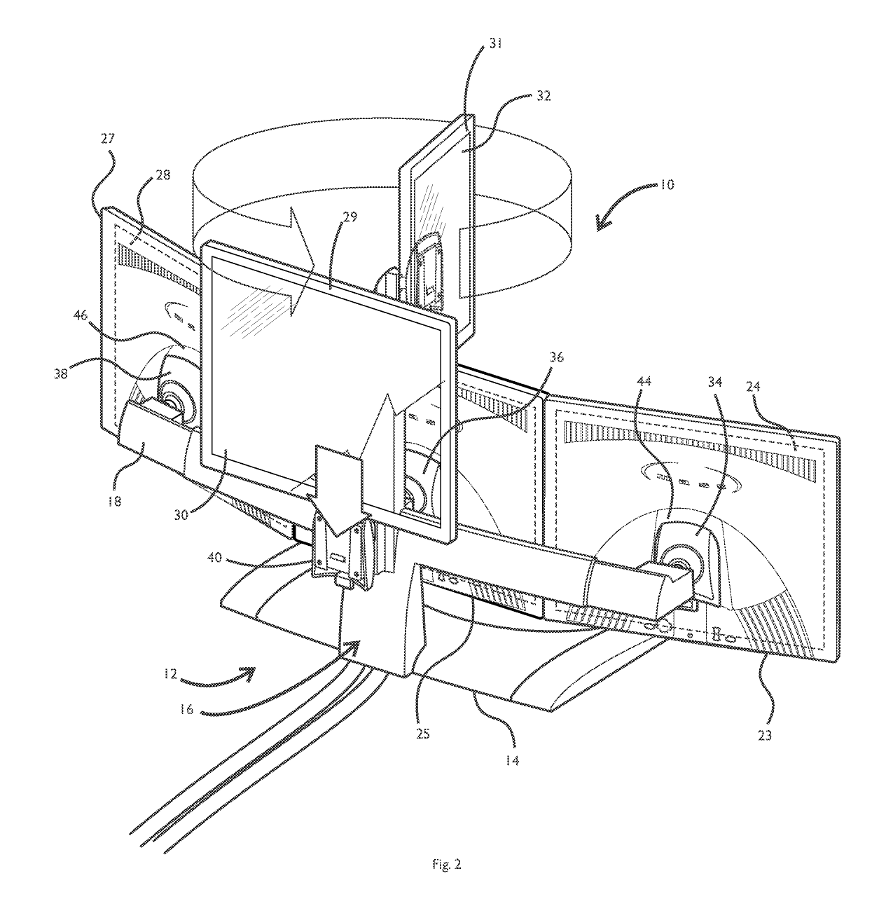

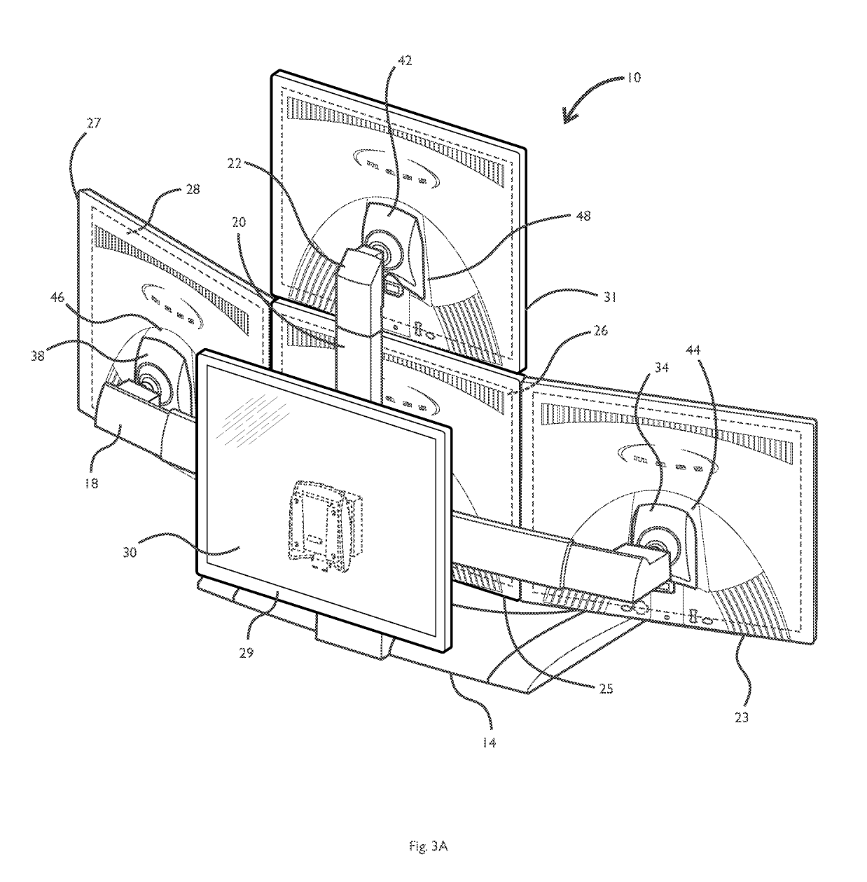

FIGS. 1, 2 and 3A and 3B show a multi-screen display system 10. The system 10 includes a support assembly 12 having a base 14, a column 16 and an arm 18. The arm can include a plurality of members joined to form an arm, or can be an integral member. The column 16 comprises a bottom column member 20 and a top column member 22. The display system 10 further comprises a first monitor 23 having a first screen 24, a second monitor 25 having a second screen 26, a third monitor 27 having a third screen 28, a fourth monitor 29 having a fourth screen 30 and a fifth monitor 31 having a fifth screen 32. In FIGS. 1 and 2, the back of the monitors 23, 25 and 27 are shown. In FIG. 3A, the back of monitors 23 and 25 are shown, but not the back of monitor 27, since monitor 29 obstructs the view of monitor 27. The respective screens 24, 26 and 28 of monitors 23, 25 and 27 are on the front of the monitors and therefore would not actually be visible from the perspectives shown in FIGS. 1-3A. Nevertheless, suggestive dashed lines are used in FIGS. 1-3A to indicate these screens.

The arm 18 includes a first support connector 34, a second support connector 36 and a third support connector 38. The bottom column member 20 includes a fourth support connector 40, and the top column member 22 includes a fifth support connector 42. On the rear of each of the monitors 23, 25, 27, 29 and 31 is a complimentary monitor-mounted connector 44, 45, 46, 47 or 48 that mates with the respective support connector 34, 36, 38, 40 or 42.

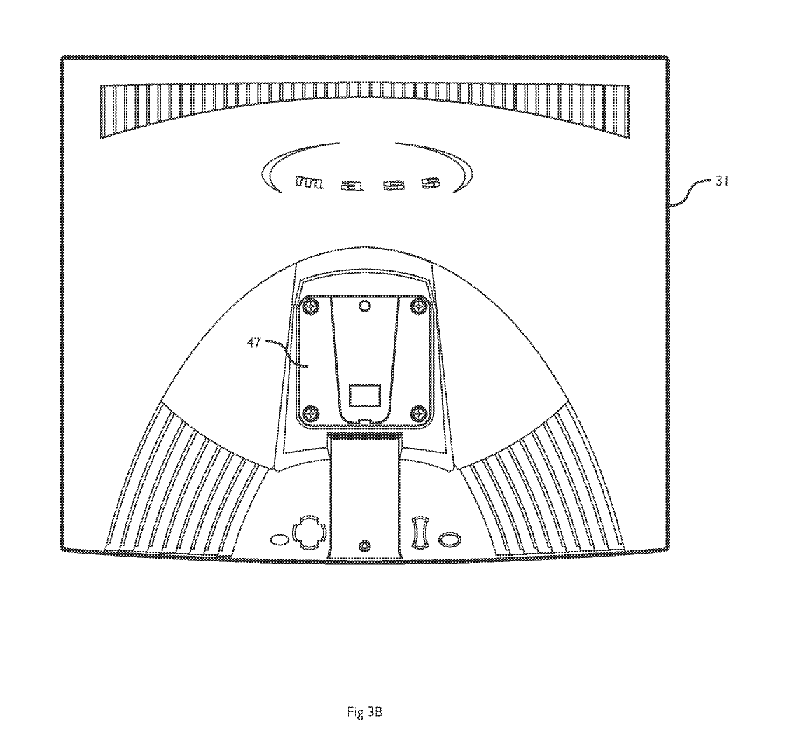

FIGS. 4, 5 and 6 show a connector apparatus 50 that includes a support connector 54 and its complimentary monitor-mounted connector 56, which are similar to any one of support connectors 34, 36, 38, 40 and 42, and complimentary monitor-mounted connectors 44, 45, 46, 47 or 48 of FIGS. 1-3B. These connectors are described in U.S. Pat. No. 6,702,604 to Moscovitch, the contents of which are hereby incorporated by reference.

The support connector 54 and complimentary screen-mounted connector 52 mate to both secure the monitor to the support assembly 12, and to electrically connect the monitor for power and data transmission. In addition, the connector apparatus 50 permits the monitor to be easily disconnected from the support assembly 12. This feature not only allows the multi-screen display system 10 to be configured as a single, double, triple, quadruple or quintuple screen display system, but also allows each monitor to be removed and transported to other sites for use with other display systems.

The complimentary screen-mounted connector 52 is intended to be secured to a housing portion of a monitor, such as an LCD monitor, having a viewing screen. The support connector 54 is similarly intended to be secured to any appropriate component of the support assembly that is used to support the monitor to which the monitor-mounted connector 52 is attached. The monitor-mounted connector 52 similarly includes a housing 56 with a wedge shaped protrusion 58 (i.e., a male component) projecting therefrom. An electrical connector 60, in this embodiment a male connector, is secured to the housing 56 at the bottom of the wedge shaped protrusion 58. The orientation of the electrical connector 60 is shown in FIG. 6.

It should be understood that the male components (both electrical and support) can be on the monitor-mounted connector 52 and the female components can be on the support connector 54. However, all permutations are envisioned. For example, the male electrical components, and the female support components can reside on the monitor-mounted connector 52, while the female electrical components and the male support components can reside on the support connector 54.

It should also be understood that the male component need not necessarily be wedge-shaped. Instead, the male component can include any protrusion that mates with a female component.

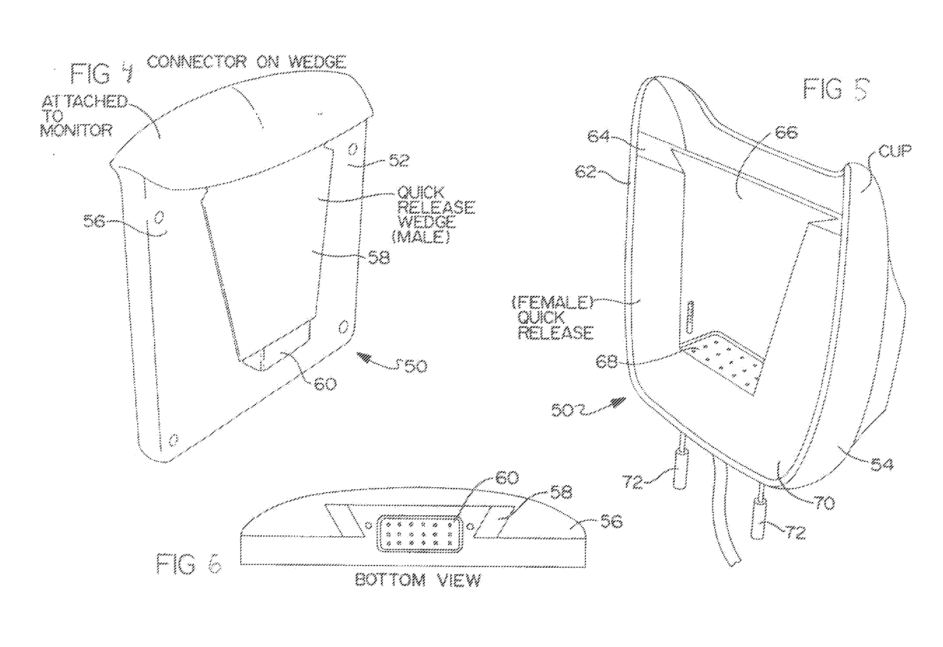

Referring to FIG. 5, the support connector 54 is shown in greater detail. The connector 54 includes a cup-shaped housing 62 having a component 64 forming a wedge-shaped recess 66. An electrical connector 68 is disposed within a lower portion 70 of the wedge shaped member 64. Threaded screws 72 may be included or used with the connector 68 to help secure the connector 68 to the connector 60.

To secure a monitor on the support assembly 12, the LCD monitor containing the screen to which is attached to the monitor-mounted connector 52 is positioned adjacent the support connector 54 and then lowered such that the wedge shaped protrusion 58 slidably engages within the wedge shaped recess 66. The wedge shaped recess 66 serves to automatically center and align the connector 60 with the connector 68 as the monitor-mounted connector 52 fully slidably engages the support connector 54.

It will be appreciated that electrical connector 60 is electrically coupled to the display element of the LCD monitor to which it is secured. Thus, one side of the connector 60 will have electrical conductors in communication with the display element. The monitor-mounted connector 52 may be attached to a housing of an LCD monitor by threaded screws or any other means that securely affixes the body of the connector 52 to a portion of the housing of the LCD monitor. Alternatively, it may be advantageous that the connector 52 form an integral part of the housing of the LCD monitor.

The mating or engaging of the support connector 54 and the monitor-mounted connector 52 does not require time consuming disassembly or any special tools. When it is desired to remove the monitor from the cup-shaped housing of the support connector 54, the user merely lifts the LCD monitor upwardly and the entire unit slidably disengages from the electrical connector (provided the aforementioned threaded screws are not engaged). The wedge-shaped components further ensure that the electrical connectors are aligned every time the LCD monitor is secured.

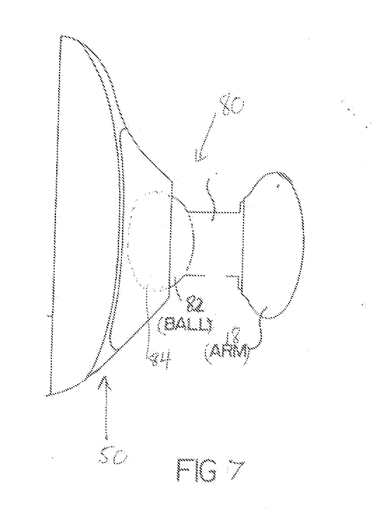

FIG. 7 shows a ball joint 80 for connecting a connector apparatus, such as the connector apparatus 50, to a support assembly, such as the support assembly 12. The arm 18 can include the male portion, or ball 82, of the ball joint 80. A female cavity 84 inside the support connector 54 encloses a portion of the ball 82. In another embodiment, the male portion of the ball joint is in the support connector, while the female cavity is in the arm. The ball joint 80 allows a screen to be tilted in various directions even as the screen is supported by the support assembly. A similar ball joint is described in the aforementioned U.S. Pat. No. 6,702,604.

The fourth screen 30 faces in a direction opposite to the second screen 26 allowing two persons facing each other to view at least one screen of the display system 10. In addition, the top column member, and therefore the fifth screen 32 attached thereto, can be rotated about a substantially vertical axis through any angle from zero degrees to three hundred and sixty degrees. As a consequence, one person can view screens 24, 26 and 28, while a second person facing the first person can view the screens 30 and 32.

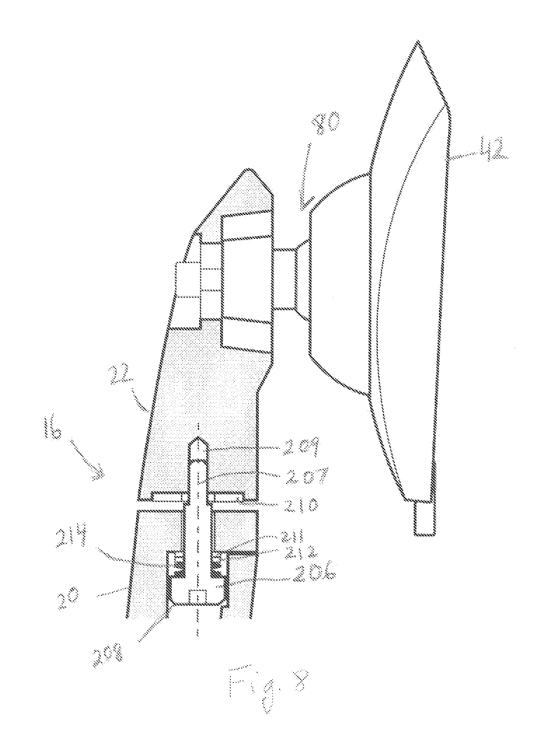

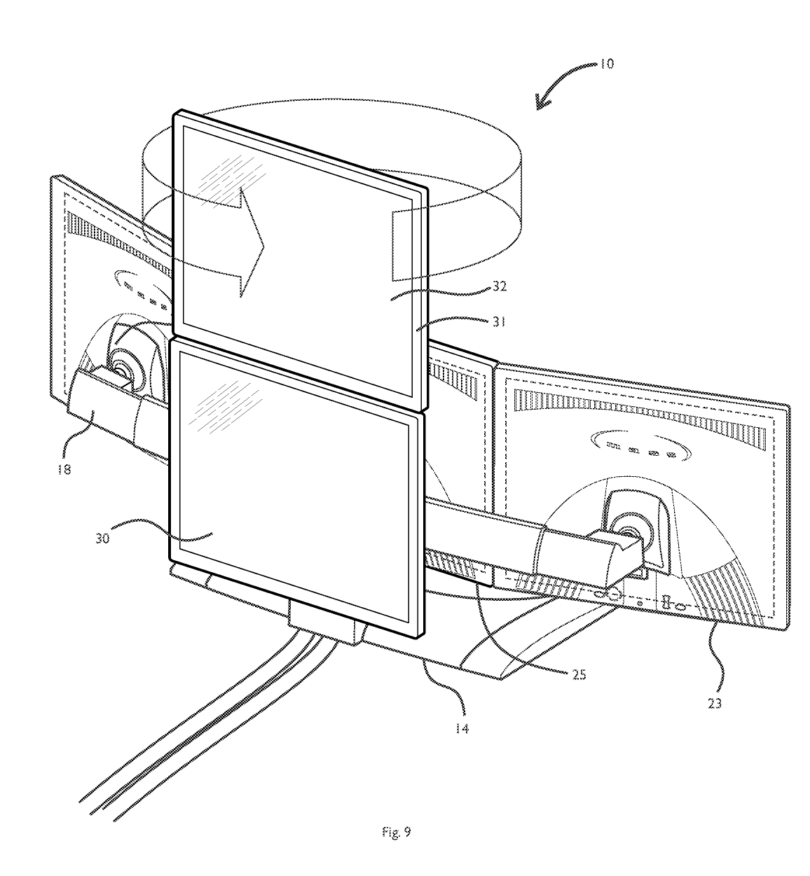

FIGS. 8 and 9 show the column 16 of FIGS. 1-3B and components to allow the fifth monitor 31 to rotate. The column 16 includes the bottom column member 20 and the top column member 22. The support connector 42 is attached to the top column member 22 via the ball joint 80. The bottom column member 20 includes a bore 208 adapted to receive a shoulder bolt 206. The shoulder bolt 206 includes a pin 207, which can be screwed in or inserted into a pin receptor 209 in the top column member 22 to enable the top column member 22, and hence the fifth monitor 31 (not shown in FIG. 8) attached thereto, to rotate or swivel. This rotation is facilitated by a washer 210, such as a nylon washer. A couple of head washers 211 and 212 further facilitate the rotation. Spring washers 214 provide stability.

In one embodiment, the pin may be releasably disposed in the pin receptor such that the entire top column member 22 and fifth monitor 31 may be lifted and separated from the bottom column member 20 before repositioning the fifth monitor 31 as desired. Alternatively, the fifth monitor 31 may be removed from the rest of the display system 10 by disconnecting the monitor-mounted connector 48 (not shown in FIG. 8) from the support connector 42.

In FIG. 9, the fifth monitor 31 is rotated nearly 180 degrees relative to the lower second monitor 25 to permit two individuals facing each other to each view one of the screens 26,32. It should be understood that the upper fifth monitor 31 can be rotated through any angle from zero to 360 degrees. For example, the upper fifth monitor 31 can be rotated to a position perpendicular to the lower second monitor 25.

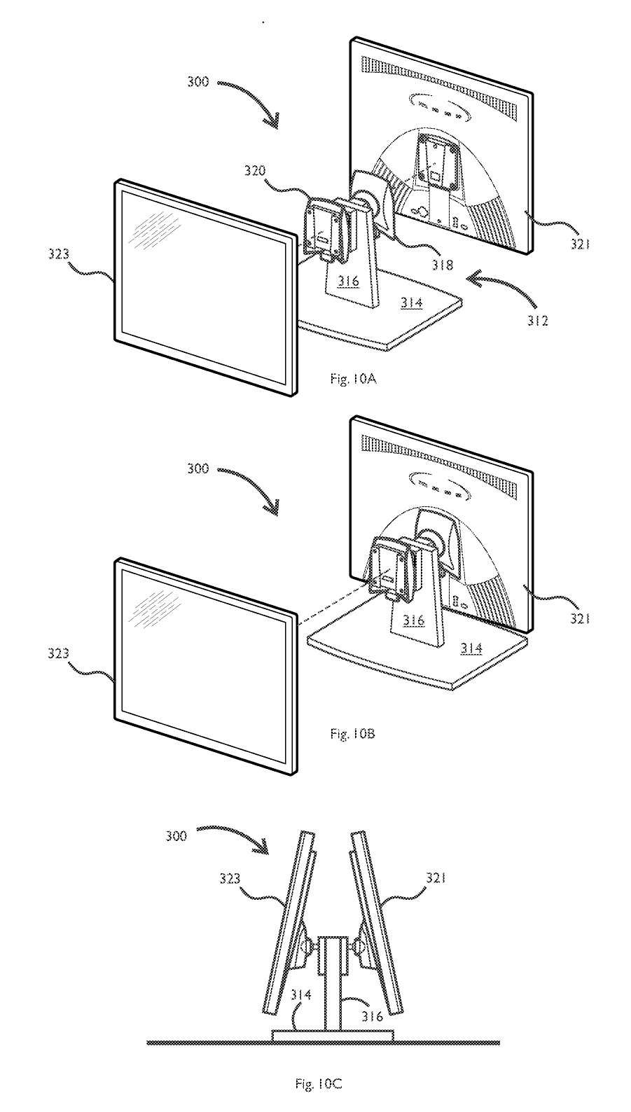

Referring now to FIG. 10A-C, a multi-screen display system 300 is shown that includes a support assembly 312 having a base 314 and a support column 316. In a different embodiment, the support assembly also includes an arm, such as the arm 18 shown in FIG. 1. A first connector 318 is connected to the support column 316. The connector can be like the one described in U.S. Pat. No. 6,702,604 to Moscovitch, which was described above, and shown as connector 54 in FIG. 5 herein. A second connector 320 is also connected to the support column 316 in a direction opposite the first connector 318. In other words, when a first monitor 321 is engaged with the first connector 318, and a second monitor 323 is engaged with the second connector 320, the second monitor 323 faces a direction that is substantially opposite the first monitor 321. Advantageously, the multi-screen display system 300 permits two persons facing each other to simultaneously view their own screen. This obviates the need for the second person to peer over the first person's shoulder, or for one screen to be turned to face the other person that plagues single monitor systems, or multi-monitor systems with screens that all face the same direction.

Referring now to FIGS. 11A-C, a multi-screen display system 350 is shown that includes a first monitor 351 having a first screen 352, a first connector 354 engaged with the first monitor 351, a second monitor 355 having a second screen 356, and a second connector 358 attached to the first connector 354 and engaged with the second monitor 355.

The first monitor 351 and the second monitor 355 face primarily opposite directions. Thus, the angle 368 between the first screen 352 and the second screen 356 is greater than two hundred and seventy degrees.

Advantageously, the multi-screen system 350 requires neither a support column nor a separate base. Instead, as shown in FIG. 11C, a bottom edge 370 of the first monitor 351 and a bottom edge 372 of the second monitor 355 can rest on a work surface 374 to support the system 350 thereon.

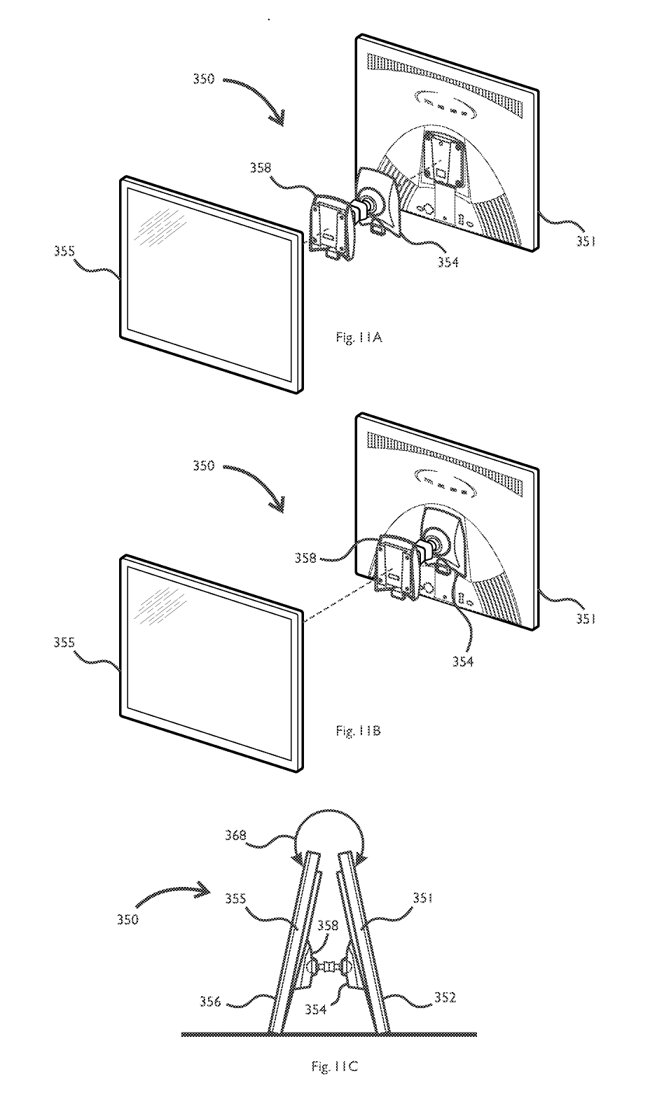

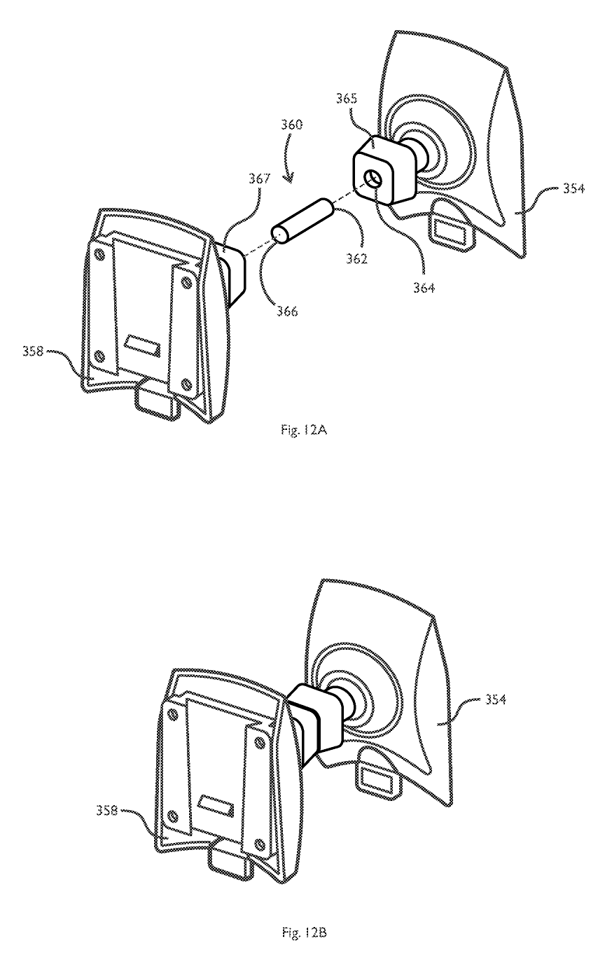

FIG. 12A (exploded view) and 12B show more detail of the connectors 354 and 358 of FIGS. 11A-C. The first connector 354 and the second connector 358 are connected with a pin 360, a first end 362 of which is forced into a hole 364 in an extending member 365 of the first connector 354, and an opposite end 366 of which is forced into a hole (not shown) of an extending member 367 of the second connector 358. The extending members 365 and 367 provide the adequate spacing between the monitors 351 and 355. It should be understood that other ways of attaching the first and second connectors 354 and 358 are possible, such as with the use of a nut and bolt, Velcro™, clip, screws and other suitable attachment means known to those of ordinary skill

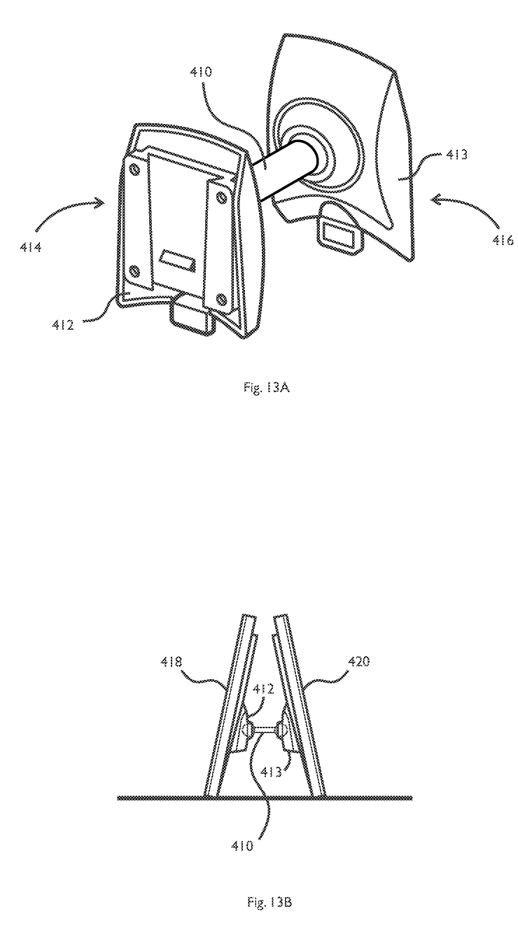

Referring to FIGS. 13A and 13B, in another embodiment, the two connectors can form one integral component. For example, instead of having two separate extending members 365 and 367 connected by the pin 360, one integral extending member 410 can be used to bridge two cup-shaped housings 412 and 413 (cf. the housing 62 of FIG. 5). Thus, a first connector 414 and a second connector 416 are integrally attached. Monitors 418 and 420 can then be engaged therewith, as shown in FIG. 13B. Ball joints 415 and 417 can be used to allow limited rotation of the monitors 418 and 420, as described in the aforementioned U.S. Pat. No. 6,702,604. Such rotation can be implemented to change the angle between the respective screens of the monitors 418 and 420.

The embodiments described above are exemplary only and are not meant to limit the scope of the invention. For example, in other embodiments, the base can be omitted if the support column is attached to a wall, ceiling, floor, desk, or any other structure that can support the support column without the use of a base. The scope of the invention is defined by the following claims.

What is claimed is:

1. A multi-screen display system comprising:
a base;
a column coupled to the base;
an arm coupled to the column;
a first monitor;
a first monitor connector for connecting the rear of the first monitor to the arm;
a second monitor;
a second monitor connector for connecting the rear of the second monitor to the arm; and
an extension, wherein the first monitor and the second monitor are capable of being a) removed from the arm, b) connected together by connecting the first monitor connector to the second monitor connector via the extension, and c) supported on a work surface by resting the bottom edge of the first monitor and the bottom edge of the second monitor thereon, such that the angle between the first screen and the second screen can exceed two hundred and seventy degrees.

2. The multi-screen display system of claim 1, wherein the first monitor connector has a first ball and socket joint and the second monitor connector has a second ball and socket joint.

3. The multi-screen display system of claim 1, wherein the work surface is horizontal and the extension includes a pin that is disposed horizontally when the first monitor and the second monitor are supported on the work surface.

4. The multi-screen system of claim 1, wherein the first and second monitors are LCD monitors.
